(19) United States
(12) Patent Application Publication
(10) Pub. No.: US 2018/0343907 A1
(43) Pub. Date: Dec. 6, 2018

(54) PROCESS FOR MAKING A TEXTURE MODIFIED FOOD PRODUCT AND TEXTURE MODIFIED FOOD PRODUCT THEREOF

(71) Applicant: Ambrosia Foods Inc., St-Nicoloas (CA)

(72) Inventor: Frédéric Rousseau, St-Nicolas (CA)

(21) Appl. No.: 15/829,109

(22) Filed: Dec. 1, 2017

Related U.S. Application Data
(63) Continuation of application No. 14/769,996, filed on Aug. 24, 2015, now abandoned.
(60) Provisional application No. 61/770,484, filed on Feb. 28, 2013.

(51) Int. Cl. A23L 29/244; A23P 30/10; A23L 29/20; A23L 29/281; A23L 33/21; A23L 13/60; A23L 29/30; A23L 19/00; A23L 7/00; A23L 5/00

(52) U.S. Cl. CPC A23L 29/244; A23P 30/10; A23L 29/20; A23L 29/281; A23L 33/21; A23V 2002/00; A23L 29/30; A23L 19/09; A23L 7/00; A23L 5/00; A23L 13/67

(57) ABSTRACT

The present invention provides a process for producing a texture modified food product, the process comprising the steps of: providing a food product; adding a fructan and a texturizing agent to the food product in order to obtain an admix food product; and crushing the admix food product to obtain a texture modified food product thereby initiating the formation of a fructan gel. The temperature of the food product during the process is maintained below about 50° C. The texturizing agent is a heat-set texturizing agent. The present invention also provides a texture modified food product obtained by the above mentioned process. The present invention also provides a texturizing composition.

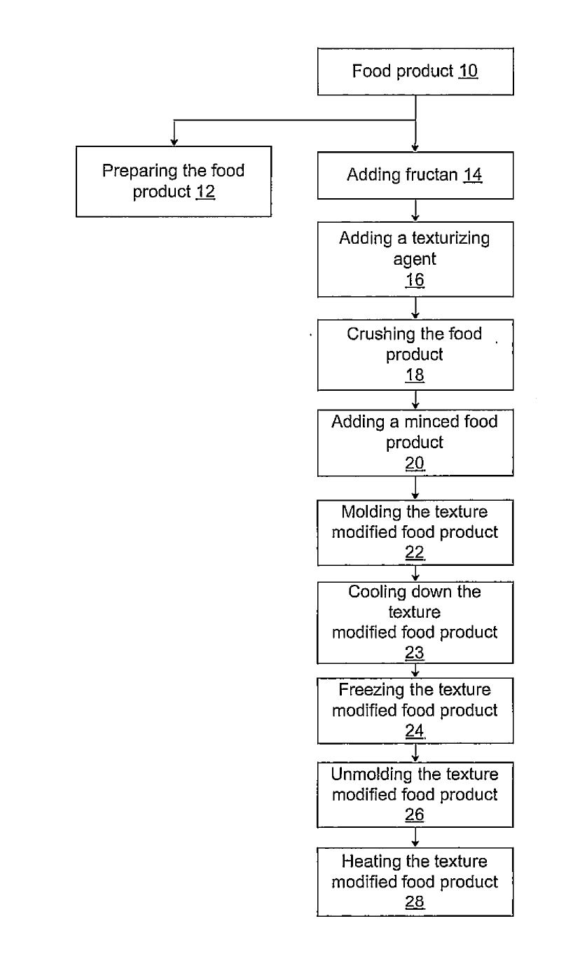

### CROSS-REFERENCE TO RELATED APPLICATIONS

This application is a continuation of U.S. patent application Ser. No. 14/769,996, filed Aug. 24, 2015, and entitled “PROCESS FOR MAKING A TEXTURE MODIFIED FOOD PRODUCT AND TEXTURE MODIFIED FOOD PRODUCT THEREOF,” which claims priority under 35 USC§ 119(e) of U.S. provisional patent application 61/770,484 filed on Feb. 28, 2013, the specification of which is hereby incorporated by reference.

### TECHNICAL FIELD

The present invention generally relates to a food product having a modified texture. More particularly, it relates to a process for producing a texture modified food product having at least a partially pureed texture.

### BACKGROUND

A significant portion of adult and child population is affected by swallowing disorders. The incidence of swallowing disorders such as dysphagia is higher in the elderly population, in patients following stroke, and those admitted to acute and chronic care hospital facilities. A patient experiencing impaired ability to swallow is at elevated risk of choking while eating and difficulty eating may contribute to nutritional insufficiency, poor health, and loss of body weight. Dysphagia can therefore lead to malnutrition, dehydration, aspiration pneumonia, and even death.

Dietary modification by altering the consistency of foods and liquids is a fundamental aspect of dysphagia management. Some researchers have speculated that certain diets and particularly those consisting of pureed foods, may be visually unappealing and lacking in taste. These foods may feel unpleasant in the mouth. Efforts to overcome these unappealing qualities have had inconsistent results. Some studies have shown that molding food into familiar shapes may help improve eating while others have found that such measures have little effect. (Groher M E et al. Dysphagia and dietary levels in skilled nursing facilities, J Am Geriatr Soc, 1995, p. 528-32, Cassens D et al. Enhancing taste, texture, appearance and presentation of pureed food improved quality of life and weight status, Nutr Rev, 1996, S51-S-54, Germain et al. A novel dysphagia diet improves the nutrient intake of institutionalized elders J Am Diet Assoc, 2006, p. 1614-23, Ballou S et al. Comparison ratings of pureed versus molded fruits; preliminary results, Dysphagia, 2000, p. 2-5, Stahlman L B et al. Perceptual ratings for pureed and molded peaches for individuals with and without impaired swallowing, Dysphagia, 2001, p. 254-62). Therefore, a food product intended for patients suffering from swallowing disorders such as dysphagia having an adapted texture would be beneficial for these patients.

Thus there is a need for a food product having an enhanced texture.

### SUMMARY OF THE INVENTION

According to a general aspect, there is provided a process for producing a texture modified food product. The process comprises the steps of: providing a food product; adding at least one fructan having a degree of polymerization of at least 10 and at least one texturizing agent; and crushing the admix food product to obtain a texture modified food product, wherein the temperature of the food product when adding the texturizing agent and when crushing the admix food product is maintained below about 50° C.

According to another general aspect, there is provided a texture modified food product obtained by the process described above.

According to another general aspect, there is provided a texture modified food product comprising about 5 wt % to 30 wt % of fructan and about 0.1 wt % to 8 wt % of texturizing agent by weight wherein the temperature while preparing the food product is maintained below about 50° C.

According to a further general aspect, there is provided a process for producing a texture modified food product. The process comprises the steps of: providing a food product; adding at least one fructan having a degree of polymerization of at least 10 and at least one texturizing agent to obtain an admix food product; and crushing the admix food product to obtain a texture modified food product, wherein the temperature of the food product when adding the texturizing agent and when crushing the admix food product is maintained below about 50° C.

In an embodiment, the process further comprises the step of heating the texture modified food product in order to obtain a heated texture modified food product. The heating step can be performed at a temperature of about 50° C. to 100° C. or of about 50° C. to 80° C. The heating step can be performed for about 10 to 240 minutes or for about 10 to 20 minutes.

In an embodiment, the at least one fructan comprises an inulin-type fructan. In an embodiment, the at least one fructan is added to the food product in an amount of about 5 wt % to 30 wt % of the admix food product. In another embodiment, the at least one fructan is added to the food product in an amount of about 8 wt % to 15 wt % of the admix food product.

In an embodiment, the at least one texturizing agent is added to the at least one food product in an amount of about 0.1 wt % to 8 wt % of the admix food product. In another embodiment, the at least one texturizing agent is added to the food product in an amount of about 1.5 wt % to 5 wt % of the admix food product.

In an embodiment, the at least one texturizing agent is a heat-set texturizing agent. In an embodiment, the at least one texturizing agent comprises at least 30 wt % of proteins. In an embodiment, the at least one texturizing agent comprises milk protein, whey protein, egg protein, egg white protein, soy protein, rice protein, wheat protein, corn protein, oat protein, peanut protein or leguminous protein. In a particular embodiment, the at least one texturizing agent comprises egg white protein. In an embodiment, the at least one texturizing agent is added in a form of a powder.

In an embodiment, the at least one fructan and the at least one texturizing agent are added simultaneously to the food product. In another embodiment, the at least one fructan and the at least one texturizing agent are added sequentially to the food product. For instance, the at least one fructan is first added to the food product in order to obtain a fructan-added food product and the at least one texturizing agent is then added.

In an embodiment, the step of adding the texture modified food product further comprises adding at least one excipient. For instance, the at least one excipient can comprise starch. In an embodiment, the step of adding at least one excipient further comprises adding and mixing starch in a liquid; heating the starch and liquid mixture before adding same to the food product.

In an embodiment, the process further comprises the step of cooking the food product and then cooling the cooked food product to lower than about 50° C. before adding the at least one texturizing agent. In an embodiment, the step of cooking the fructan-added food product and then cooling the cooked fructan-added food to lower than about 50° C. before adding the at least one texturizing agent.

In an embodiment, the process further comprises the step of adding a minced food product to the texture modified food product. In an embodiment, the minced food product is added to the texture modified food product in an amount of about 50% to 90% by weight of the minced food product and the texture modified food product.

In an embodiment, the process further comprises the step of freezing the texture modified food product to obtain a frozen texture modified food product.

In an embodiment, the process further comprises the step of molding the texture modified food product to obtain a formed texture modified food product. In an embodiment, the process further comprises the step of unmolding the formed texture modified food product to obtain an unmolded formed texture modified food product. In an embodiment, the process further comprises the step of freezing one of the formed texture modified food product and the unmolded texture modified food product to obtain a frozen formed texture modified food product or a frozen unmolded texture modified food product. In an embodiment, the process further comprises the step of unmolding the frozen formed texture modified food product to obtain an unmolded frozen formed texture modified food product. For instance, the step of freezing can be carried out at a temperature below about 0° C. For instance, the step of freezing can be carried out at a temperature below about −18° C.

In an embodiment, the crushing step comprises shearing the admix food product.

In an embodiment, the process further comprises the step of adding a nutraceutical ingredient or a functional ingredient to one of the food product and the texture modified food product.

In an embodiment, the food product comprises at least one of meat, vegetable, fruit, and fish.

According to a further general aspect, there is provided a texture modified food product obtained by the process defined above.

According to still another general aspect, there is provided a texture modified food product comprising a crushed food product including about 5 wt % to 30 wt % of at least one fructan and about 0.1 wt % to 8 wt % of at least one texturizing agent wherein the temperature while preparing the crushed food product is maintained below about 50° C. when adding the at least one texturizing agent and crushing a food product including the at least one texturizing agent.

In an embodiment, the texture modified food product is heated to a temperature above about 50° C. to obtain a heated texture modified food product.

In an embodiment, the at least one texturizing agent is a heat-set texturizing agent. For instance, the at least one texturizing agent can comprise at least 30 wt % of proteins. In an embodiment, the at least one texturizing agent comprises milk protein, whey protein, egg protein, egg white protein, soy protein, rice protein, wheat protein, corn protein, oat protein, peanut protein or leguminous protein. In a particular embodiment, the at least one texturizing agent comprises egg white protein.

In an embodiment, the at least one fructan comprises an inulin-type fructan.

In an embodiment, the at least one fructan is added to the food product in an amount of about 8 wt % to 15 wt % of the texture modified food product. In another embodiment, the at least one texturizing agent is added to the food product in an amount of about 1.5 wt % to 5 wt % of the texture modified food product.

In an embodiment, the at least one texturizing agent is added in a form of a powder.

In an embodiment, the texture modified food product further comprises at least one excipient. The at least one excipient can comprise starch.

In an embodiment, the food product comprises at least one of meat, vegetable, fruit, and fish.

According to another general aspect, there is provided a texturizing composition for food products comprising a crushed food product including a mechanical-set texturizing agent and a heat-set texturizing agent wherein the composition is maintained below about 50° C. during preparation of food products. The crushed food product can comprise about 5 wt % to 30 wt % of the mechanical-set texturizing agent and about 0.1 wt % to 8 wt % of the heat-set texturizing agent.

The present document refers to a number of documents, the contents of which are hereby incorporated by reference in their entirety.

### BRIEF DESCRIPTION OF THE DRAWING

The appended FIGURE shows a flow chart illustrating a process for preparing a texture modified food product in accordance with an embodiment.

### DETAILED DESCRIPTION

In reference to the accompanying FIGURE, a process for making a texture modified food product having an adapted texture, in accordance with an embodiment, is described below. Although the texture modified food product is intended amongst others for patients suffering from dysphagia, it is also intended for healthy population wishing to consume texture modified food products such as babies, elderly and the like.

A food product is first provided at step 10. The food product includes products intended for human consumption such as, but not limited to: vegetables, fruits, meats, fishes and/or the like. It can also include a combination of several food products.

In one embodiment, the food product is prepared at step 12. The term “prepare” refers to the process of preparing food, and optionally using heat (cooking). The food product can be cooked according to a desired recipe such as it can be peeled, cut, mixed with different ingredients, seasoned as desired and cooked using heat such as dry heat (conventional oven, convection oven, microwave) or humid heat (vapour, water).

A fructan (at least one, one or more or a mixture of fructans) is added to the food product at step 14 to obtain a fructan-added food product. The term “fructan” refers to a polymer of fructose molecules synthesized by plants or by microorganisms. Fructans can be naturally obtained or chemically synthesised. Fructans with a short chain length are known as fructooligosaccharides, whereas fructans with a longer chain are known as inulin (or inulin-type fructans).

In one embodiment, the fructan comprises inulin. The term “inulin” refers to a long chain made up of 22-60 fructose molecules and one glucose molecule at one end. As known, the fructose molecules are connected by β-(2-1) bonds and the last fructose is linked with a glucose by β-(1-2) bonds. Inulin can be extracted from plants such as chicory root, dahlia tuber, Jerusalem artichoke or from other plants which are widely distributed worldwide. It is known that the average molecular weight and degree of polymerisation of inulin depend on the source of inulin, the time of harvest and the process of production. Inulin naturally contains a large quantity of oligosaccharides with a degree of polymerization of less than 10. Commercial inulin extracted from chicory, for example, contains about 25% of oligosaccharides, and contains more than 50% of oligosaccharides with a degree of polymerization of 2 to 20. Inulin is also known as a prebiotic which is a non-digestible food ingredient stimulating the growth and/or activity of bacteria in the digestive system.

Fructans with a degree of polymerization of at least 10 can form a gel. The expression “degree of polymerization” (hereinafter “DP”) refers to the number of monomeric units in a macromolecule, polymer or oligomer molecule. Suitable methods to determine the DP are known. In general, increasing DP correlates with higher mechanical gel strength. In one embodiment, the fructans comprises fructans having a DP of at least 10. In one embodiment, the fructans comprises fructans having a DP of 18 and/or a DP of 18 and more.

The term “gel” refers to a substantially cross-linked system which exhibits no flow when in the steady-state. A gel is a solid, jelly-like material that can have properties ranging from soft and weak to hard. Following polymerization, a gel can then provide texture to a food product that is relatively smooth.

Polymerization of a fructan gel can be initiated following mixing fructan with a colloidal mill, a rotor-stator, a homogenizer or a micro fluidizer as known (Kim Y. et al. “Factors affecting gel formation of inulin” Carbohydrate polymers, 2001, p. 135-145). Fructans are added to the food product to obtain a fructan-added food product. The expression “fructan-added food product” refers to a food product comprising fructan. The amount of fructan added to the food product can depend on the nature of the food product and the desired texture prior to a final heating step. In one embodiment, the amount of fructan added to the food product is about 5 wt % to 30 wt % of the admix food product, as it will be described in more details below, and in an alternative embodiment about 8 wt % to 15 wt % of the admix food product. In one embodiment, the amount of fructan added to the food product is superior to about 8 wt % of the admix food product. In one embodiment, the amount of fructan added to the food product is inferior than about 12 wt % of the admix food product. In yet another embodiment the amount of fructan added to the food product is between about 8 wt % and about 10 wt % of the admix food product. In a further embodiment the amount of fructan added to the food product is between about 10 wt % and 12 wt % of the admix food product.

The expression “admix food product” refers to a food product mixed with additional components. As described herein specifically, an admix food product is a food product that is mixed with both a fructan and a texturizing agent (a fructan and texturizing agent-added food product).

The expression “by weight of the admix food product” refers to the weight of the food product cooked if the cooking step is performed at step 12 or uncooked if no cooking step is performed and including fructans and texturizing agent, as it will be described in more details below. As such, when the food product is cooked the weight of said food product includes the ingredients such as sauce, vegetables, and spices. Food product can be weighed with a weighing scale or any other suitable known means.

One skilled in the art will appreciate that the fructan can be added as a mixture, i.e. as a composition including two or more components.

In another embodiment, the fructan-added food product is cooked as described above. In other words, the fructan is added to the food product before or during the cooking step.

The process further comprises adding a texturizing agent and/or a mixture of texturizing agent to the food product at step 16 to obtain a texturizing agent-added food product. The term “mixture” refers to a composition comprising two or more different agents which are mixed but not chemically combined. For example, a mixture of fructans includes two or more fructans which are mixed but not chemically combined. In an embodiment, the fructans in a mixture both have a degree of polymerization of at least 10. Texturization agent used herein can be a single texturization agent or one or more (a mixture) of texturization agents. A mixture of texturizing agent includes two or more texturizing agents which are mixed but not chemically combined.

The (at least one, one or more or a mixture of) “texturizing agent” refers to a component to increase, modify and/or enhance the overall texture or mouthfeel of food products. Texturizing agents used herein are suitable for addition to a food product. In an embodiment, the texturizing agent can be a heat-set texturizing agent, meaning a texturizing agent that sets (e.g. coagulates) upon exposure to heat. In an embodiment, heat setting of the texturizing agent occurs at temperatures above about 50° C. In an embodiment, the texturizing agent is a proteinaceous substance which sets upon exposure to heat. The texturizing agent can have at least 30 wt % protein for use in the process described herein, or at least 35 wt %, or at least 40 wt %, or at least 45 wt %, or at least 50 wt %, or at least 55 wt %, or at least 60 wt % or more. Examples of texturizing agents include milk proteins (e.g. proteins present in milk from a mammal (e.g. bovine, sheep, goat etc.) such as caseins and whey proteins), egg proteins (e.g. egg white proteins and egg yolk proteins), albumin proteins, and vegetable or leguminous proteins (e.g. soy protein, rice protein, wheat protein, corn protein, oat protein, peanut protein) and/or mixtures thereof. The texturizing agent can be a protein concentrate or isolate.

In an embodiment, the texturizing agent is at least one of egg white protein and milk protein. In an embodiment, the texturizing agent is at least one of egg white protein and whey protein. In a further aspect, the texturizing agent is at least one of whey protein concentrate, whey protein isolate, egg white protein concentrate and egg white protein isolate.

Functional milk proteins can be used as texturizing agent. Functional milk proteins can be used to replace eggs by providing the benefits and functionality of milk product and delivering the functionality of eggs. As an example, a milk protein texturizing agent can be EGGSTEND® 220 or EGGSTEND® 300, both products being commercially available.

The process further comprises adding an excipient such as and without being limitative starch (e.g. rice starch, corn (maize) starch, potato starch, wheat starch, tapioca, etc.). The starch can be modified starch such as and without being limitative modified rice starch. The starch can be pre-activated before being added to the food product or to the texturizing agent and/or the fructan. In one aspect, the pre-activation step includes mixing the starch with a suitable liquid, such as water and heating the resulting mixture to a desired consistency (e.g. a thicker consistency). Before being added to the texturizing agent or the food product including the texturizing agent, the pre-activated excipient (e.g. starch) can be cooled down to a temperature below about 50° C. As mentioned above, the excipient, pre-activated or not, can be added to the texturizing agent and/or the fructan, to the food product, or to the food product including the texturizing agent and/or the fructan. For instance, the excipient can added to the food product in either step 14 or step 16 of the FIGURE.

The expression “egg white” refers to the clear liquid contained within an egg. The egg white protects the yolk and provides additional nutrition for the growth of the embryo. The egg white can be from any oviparous animal laying eggs which comprise an egg white such as chicken, ostrich or quail. In an embodiment, the texturization agent mixture can comprise egg white. In another embodiment, the texturization agent mixture can comprise egg white and other components such as the yolk of the egg providing additional nutrients to the resulting food product.

The expression “egg yolk” refers to the part of the egg that feeds the developing embryo within the egg. The egg yolk can be from any oviparous animal laying eggs which comprise a yolk such as chicken, ostrich or quail. In one embodiment, the egg yolk can come from the same animal as the egg white. The egg yolk can also come from the same egg as the egg white.

As the activity of the texturizing agent can be altered at temperature higher than about 50° C., when the food product or the fructan-added food product is cooked, the food product, optionally including fructan, is cooled down at a temperature to below about 50° C. prior to adding the texturizing agent or texturizing agent mixture. The food product can be cooled down by any known process such as by leaving the food product at room temperature, disposing the food product in a refrigerator or any other suitable alternative. In addition, the food product should not be heated to or have a temperature higher than about 50° C. during the next steps of the preparation process. The temperature should therefore be maintained below about 50° C. until the final heating step as described below.

The fructan and the texturizing agent can be added concurrently or sequentially. In one embodiment, the fructan and the texturizing agent are added sequentially to the food product. The term “sequentially” refers to adding the fructan and then the texturizing agent or adding the texturizing agent and then the fructan to the food product.

The fructan and, optionally the texturizing agent can be hydrated before being added to the food product.

The addition of texturizing agent to the fructan-added food product enhances the texture of the fructan-added food product provided by the fructan as described below. The amount of texturizing agent added to the food product can be adjusted according to the percentage of water contained in the food product. As such, a food product containing a higher percentage of water can require a greater amount of texturizing agent in order to obtain a desired texture. For example, vegetables can require a greater amount of texturizing agent than ground beef. In addition, the amount of texturizing agent added to the food product can be adjusted according to the desired food texture of the resulting product. For example, if a consumer wishes to obtain cooked carrots having a relatively firm texture, more texturizing agent can be added thereto than if the consumer wishes to obtain cooked carrots having a smooth texture. In an embodiment, the amount of texturizing agent added to the food product is about 0.1 wt % to 8 wt % of the admix food product. In other embodiments, the amount of texturizing agent added to the food product is above 0.5 wt %, is between about 1.5 wt % to 4 wt %, about 1 wt % to 5 wt %, about 2 wt % to 3 wt %, about 3 wt % to 4 wt %, superior to about 1.5 wt % or between about 1.5 wt % and 5 wt % of the food product.

In an embodiment, the texturizing agent is added as a solid powder state such as and without being limitative, a powdered mixture which can include other components. The term “powder” refers to a dry, bulk solid composed of a relatively large number of fine particles that can flow freely when shaken or tilted. As such, the texturizing agent can be dried and provided as a powder. For example, egg white can be dried and provided as a powder. Suitable methods for drying egg white are known.

In one embodiment, when the food product is not cooked or when it is cooled down at a temperature below about 50° C., the fructan and the texturizing agent can be added simultaneously i.e. at the same time to the original food product.

The admix food product is then crushed at step 18 to obtain a texture modified food product. The expression “texture modified food product” refers to a food product having a texture that is smooth enough to preclude the need for chewing prior to ingestion and comprising a fructan and a texturizing agent or mixture of texturizing agent. The texture modified food product has the consistency of a puree which is a soft creamy paste or a thick liquid having an enhanced texture provided by the fructan and the texturizing agent. Therefore, the crushing step continues until the resulting food product particles are sufficiently reduced in size to preclude the need for chewing prior to ingestion. The texture modified product is therefore easy to swallow for the consumer. For example, when the food product is carrot, the crushing step can continue until the carrot has a substantially “pureed like” texture.

In addition, the crushing step initiates the formation of a fructan gel. As the admix food product is crushed, the fructan starts to polymerize and forms a fructan gel. At this step, the fructan gel is not completely formed i.e. it could exhibit flow when in the steady-state. The admix food product can be crushed using, for instance and without being limitative, a blender, a colloidal mill, a rotor-stator, an homogenizer, a microfluidizer, or combination thereof. In one embodiment, the food product with texturization agent is crushed into microparticles to form an emulsion resulting in a smooth food product. As such, the texturization agent is dispersed into the food product which results in a smooth food product.

In another embodiment, the food product, the texturizing agent and the fructan can be sheared. The term “shearing” refers to chopping, blending, pureeing and liquefying foods by known shear mixing process, such as homogenizing, sonolating, or any other known shear mixing processes. Suitable speeds of rotation can be in the range of about 1000 to 20 000 rpm or more, although other speeds can be useful depending on the size and type of mixer. Following shearing, the food product is reduced into a relatively smooth food product having a “pureed like” texture.

In an embodiment, a minced food product can be added to the crushed food product at step 20. A “minced food product” refers to a food product cut into pieces having a size larger than the size of the texture modified food product but yet small enough to preclude the need for chewing prior to ingestion. The “minced food product” can come from the same food product as the texture modified food product or can come from a different food product. For instance, the minced food product and the texture modified food product can both come from a chicken. As such, the texture of the texture modified chicken is further modified by adding minced chicken thereto.

The minced food product can include at least one of fructan and texturizing agent or it can be substantially free of at least one of fructan and texturizing agent.

The food product can be minced for instance by using a hammer cutler mill or any similar equipment. In one embodiment, the food product is minced into pieces smaller than about 5 mm×5 mm×5 mm or having a diameter smaller than about 5 mm. The size of the minced food product can be adapted according to the desired resulting texture. In an embodiment, the minced food product is added to the texture modified food product in an amount of about 50 wt % to 90 wt % of the resulting food product i.e. including the minced food product and the texture modified food product. The texture modified food product and the minced food product can be weighted as previously described. In an embodiment, the texture modified food product is added to the minced food product in an amount of about 0.01 wt % to 50 wt % of the resulting food product. For example, when the texture modified food product is meat, shredded meat can be added thereto further modifying the texture of the meat.

In an embodiment, the texture modified food product comprising or not the minced food product can be molded at step 22 to obtain a formed texture modified food product. The expression “formed texture modified food product” refers to the texture modified food product having a defined or predetermined shape or form. The texture modified food product is deposited in an individual mold or form which serves to sculpt it into a desired shape. The mold can be any shape, although use of a mold representing the shape of the original food product can be suitable. For example, a texture modified food product that was derived from a corn, is placed in a mold which forms it into a shape representing a longitudinally piece of corn on the cob, a texture modified food product derived from meat such as beef can be molded into the form of a steak. The texture modified food product can be deposited in such molds or forms by any known technique. For instance and without being limitative, a silicon mold can be used and a plastic film can be applied over the texture modified food product following the molding step.

The texture modified food product can be cooled down prior to the freezing step or not, in step 23. In an embodiment, the formed texture modified food product or the texture modified food product is then allowed to cool down. In an embodiment, the texture modified food product, formed or not, is placed in a refrigerator, at a temperature below about 4° C., and is allowed to rest. The cooling step allows the inulin gel to continue its formation. In an embodiment, the texture modified food product, formed or not, can stay in the refrigerator for one minute up to 24 hours.

In an embodiment, the texture modified food product is frozen at step 24 to obtain either a frozen texture modified food product, a frozen formed texture modified food product or a frozen unmolded texture modified food product. The expressions “frozen texture modified food product”, “frozen formed texture modified food product” and “frozen unmolded texture modified food product” refer to the texture modified food product, the formed texture modified food product or the unmolded texture modified food product being frozen. Conventional or cryogenic freezing can be employed, generally to a temperature below about 0° C. and in a different embodiment below about −18° C. Flash or blast freezing to quickly freeze texture modified food products can also be employed. As such, water inside food freezes in a very short period without forming large crystals, thus avoiding damage to the fructan gel. The freezing step allows the preservation of the fructan gel integrity. As such, frozen product can be stored, packaged and/or shipped while preserving its texture and taste.

In an embodiment, the formed texture modified food product or the frozen formed texture modified food product can be unmolded at step 26 to obtain an unmolded formed texture modified food product and a unmolded frozen formed texture modified food product. The expressions “unmolded formed texture modified food product” or “unmolded frozen formed texture modified food product” refer to a formed texture modified food product from which the mold has been removed. Unmolding techniques are known in the art. As mentioned above, in an alternative and non-limitative embodiment, the formed texture modified food product can be unmolded prior to the freezing step, if any.

Following the unmolding step, if any, or the freezing step, the texture modified food product can be stored in the freezer for a relatively long period of time.

In an embodiment, the texture modified food product, the formed texture modified food product, the unmolded formed texture modified food product, the frozen formed texture modified food product or the frozen unmolded texture modified food product can be heated at step 28 to obtain a heated texture modified food product prior to serving for consumption. The expression “heated texture modified food product” refers to a heated food product containing a fructan and a texturizing agent. When the texturizing agent contained in the resulting food product is heated, it reacts with the fructan gel and the firmness of the food product increases. As such without incurring substantial deformation, the heated texture modified food product can be manipulated when warm. The heating step can be performed using dry heat (conventional oven, convection oven, or microwave) or humid heat (vapour, or water). The heating step is performed at a temperature sufficiently high enough for the texturizing agent to react with the fructan gel. In an embodiment, the heating step can be between 10 to 240 minutes. In an embodiment, the heating step can be between 10 minutes to more than 1 hour. In one embodiment, the heating step is performed for about 12 to 20 minutes. In an embodiment, the heating step is performed for about 15 minutes. When frozen texture modified food product is subjected to rethermalisation, the heating step can be performed for about 1 to 4 hours. In an embodiment, the heating step is performed at a temperature of about 50 to 100° C. or about 65° C. to 75° C. or about 50 to 80° C.

The combination of the fructan gel and the texturizing agent solidifying the fructan gel during the heating step allows the production of a texture modified food product which can be manipulated when warm.

In an embodiment, a nutraceutical ingredient or a functional ingredient can be added to the food product at any step along the process. A nutraceutical ingredient refers to any product derived from food sources that provides extra health benefits in addition to the basic nutritional value found in foods. These ingredients typically claim to prevent chronic diseases, improve health, delay the aging process, and increase life expectancy such as dietary supplements, antioxidants, isoflavonoids, omega 3 fatty acids, ginseng, garlic, oil and so on.

Functional ingredients are similar in appearance to, or can be, a conventional food that is consumed as part of a usual diet, and are demonstrated to have physiological benefits and/or reduce the risk of chronic disease beyond basic nutritional functions, i.e. they contain bioactive compound such as carotenoids, dietary fiber, fatty acids, phenolics, plant sterols, prebiotics, probiotics, soy, and/or phytoestrogens.

Addition of a nutraceutical or functional ingredient to the texture modified food product can provide medical benefits preventing and/or treating the condition or disease the consumer can be suffering from.

There is also provided a texture modified food product obtained by the process defined above.

There is also provided a texture modified food product comprising a crushed food product including about 5 wt % to 30 wt % of fructan and about 0.1 wt % to 8 wt % of texturizing agent wherein the temperature while preparing the crushed food product including adding the fructan and the texturizing agent is maintained below about 50° C.

While the risks of choking upon swallowing the texture modified food product are low, the texture modified food product provides a pleasant meal experience to the consumer. In addition, the texture of the food product can be modified according to the consumer need and/or desire. As such, the texture modified food product is adapted for patients suffering from swallowing disorders such as dysphagia or for any one wishing to eat a texture modified food product such as elderly or babies.

An embodiment of a texture modified food product described herein is one that comprises about 5 wt % to 30 wt % of fructan and about 0.1 wt % to 8 wt % of texturizing agent wherein the temperature while preparing the food product is lower than about 50° C.

### EXAMPLES

### Example 1

### Preparation of a Texture Modified Food Product from Carrots

Carrots are cooked using steam. The carrots are then cooled down to a temperature about below 50° C. 83 grams (g) of carrots are transferred into a bowl and 12 g of inulin having a degree of polymerisation of at least 10, 3 g of egg white in powder and 2 g of butter are added thereto, i.e. 83 wt % of food product, 12 wt % of inulin, and 3 wt % of egg white. The carrots, the inulin, the egg white, and the butter are mixed using a colloidal mill. The mixture is recirculated five times in the colloidal mill to obtain a texture modified food product. In the colloidal mill, the temperature of the mixture is maintained below about 50° C. The texture modified food product is then dispensed into individual molds having the shape of a carrot. A plastic sealing film is placed over the open portion of the molds. The molded carrots are then allowed to rest for about 1 hour. The molded carrots are then frozen to about −18° C. The individual frozen formed carrots are removed from the molds. Before serving, the carrots are placed on plates. The carrots are then heated at about 50° C. to about 100° C. for about 15 minutes using a steam oven.

### Example 2

### Preparation of a Texture Modified Food Product from Meat

Minced beef is cooked and then cooled down to a temperature below about 50° C. 56.6 g of cooked minced beef is transferred into a bowl and 10 g of inulin having a degree of polymerization of at least 10, 2 g of egg white powder, 30 g of beef broth and 1.4 g of spices are added thereto, i.e. 56.6 wt % of food product, 10 wt % of inulin, and 2 wt % of egg white. The ingredients are mixed using a colloidal mill. The mixture is recirculated five times in the colloidal mill to obtain a texture modified food product. In the colloidal mill, the temperature of the mixture is maintained below about 50° C. The texture modified food product is then dispensed into individual molds having the shape of a steak, meat balls, or meat patties. A plastic sealing film is placed over the open portion of the molds. The molded steaks are then allowed to rest for about 1 hour. The molded steaks are then frozen to about −18° C. The individual frozen formed steaks are removed from the molds. Before serving, the steaks are placed on plates. The steaks are then heated at about 50° C. to 100° C. for about 15 minutes using a convection oven.

It will be appreciated that the methods described herein may be performed in the described order, or in any suitable order.

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the scope of the invention as defined in the appended claims.

The invention claimed is:

1. A process for producing a texture-modified food product, the process comprising the steps of:
providing a food product selected from: meat, vegetable, fruit, and fish;
adding an inulin having a degree of polymerization of at least 10 to the food product, and adding egg white protein to the food product to obtain an admix food product;
crushing the admix food product to obtain a texture-modified food product; and
wherein maintaining a temperature of the food product below 50° C. when adding the egg white protein and when crushing the admix food product;
wherein the inulin and the egg white protein are added simultaneously or sequentially to the food product wherein the at least one texturizing agent is a heat-set texturizing agent.

2. The process of claim 1, wherein the degree of polymerization is 18 or more.

3. The process of claim 1, further comprising the step of heating the texture-modified food product to obtain a heated texture-modified food product, wherein the heating step is performed at a temperature of about 50*C to about 100*C.

4. The process of claim 3, wherein the heating step is performed for about 10 to about 240 minutes.

5. The process of claim 1, wherein the inulin-type fructan is added to the food product in an amount of about 5 wt % to about 30 wt % of the admix food product.

6. The process of 1, wherein the egg white protein is added to the food product in an amount of about 0.1 wt % to about 8 wt % of the admix food product.

7. The process of claim 1, wherein the egg white protein is added in form of a powder.

8. The process of claim 1, wherein the egg-white is first added to the food product to obtain an egg white-added food product and the inulin is then added to obtain an admix food product.

9. The process of claim 1, wherein the inulin is first added to the food product to obtain an inulin-added food product and the egg white protein is then added to obtain an admix food product.

10. The process of claim 8, further comprising the step of cooking the food product to obtain a cooked food product and then cooling the cooked food product to lower than 50° C. before adding the egg white protein to form the egg white added food product.

11. The process of claim 9, further comprising the step of cooking the inulin-added food product to obtain a cooked inulin-added food product and then cooling the cooked inulin-added food product to lower than 50° C. before adding the egg white protein to form the admix food product.

12. The process of claim 1, wherein the crushing step comprises shearing the admix food product.

13. A texture-modified food product selected from: meat, vegetable, fruit, and fish admixed with about 5 wt % to about 30 wt % of inulin having a degree of polymerization of at least 10 and about 0.1 wt % to about 8 wt % of egg white protein.

14. The texture-modified food product of claim 13, wherein the texture-modified food product is heated to a temperature above about 50° C. to obtain a heated texture-modified food product.

15. A process for producing a texture-modified food product, the process consisting essentially of steps of:
providing a food product selected from: meat, vegetable, fruit, and fish;
adding an inulin having a degree of polymerization of at least 10 to the food product, and adding egg white protein to the food product to obtain an admix food product;
crushing the admix food product to obtain a texture-modified food product; and
maintaining a temperature of the food product below 50° C. when adding the egg white protein and when crushing the admix food product; wherein the inulin and the egg white protein are added simultaneously or sequentially to the food product.
